(19) United States
(12) Patent Application Publication
(10) Pub. No.: US 2025/0163826 A1
(43) Pub. Date: May 22, 2025

(54) PROPULSION SYSTEM WITH A CONTROL SYSTEM TO DETERMINE HEALTH INFORMATION

(71) Applicant: General Electric Company, Schenectady, NY (US)

(72) Inventors: Stefan Joseph Cafaro, Chapel Hill, NC (US); Kum Kang Huh, Niskayuna, NY (US); Brendon Matthew Leeker, Cincinnati, OH (US)

(21) Appl. No.: 18/515,936

(22) Filed: Nov. 21, 2023

(51) Int. Cl. F01D 21/00; F02C 6/00

(52) U.S. Cl. CPC F01D 21/003; F02C 6/00; F05D 2220/74

(57) ABSTRACT

A propulsion system is provided having: a gas turbine engine having a turbomachine, the turbomachine including a compressor, a turbine, and a shaft rotatable with the turbine; and an electric assembly including: an electric machine rotatable with the shaft; a control system in electric communication with the electric machine, the control system configured to receive data from the electric machine indicative of an electric power flow to or from the electric machine and determine health information of the gas turbine engine in response to the received data.

### FIELD

The present subject matter relates generally to a propulsion system, such as a hybrid-electric propulsion system for a vehicle, such as an aeronautical vehicle.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly.

The gas turbine engine may be part of a hybrid-electric propulsion system further including one or more electric machines rotatable with the gas turbine engine. A control system operable with the hybrid-electric propulsion system to provide desired operations for the hybrid-electric propulsion system would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a top view of an aircraft according to various exemplary embodiments of the present disclosure.

FIG. 2 is a side view of the exemplary aircraft of FIG. 1.

FIG. 3 is a schematic, cross-sectional view of a gas turbine engine in accordance with an exemplary embodiment of the present disclosure, as may be mounted to the exemplary aircraft of FIG. 1.

FIG. 4 is a schematic view of a propulsion system in accordance with an exemplary embodiment of the present disclosure.

FIG. 5 is a graph of a raw data signal in accordance with an exemplary aspect of the present disclosure.

FIG. 6 is a graph of a processed data signal in accordance with an exemplary aspect of the present disclosure.

FIG. 7 is a graph of a processed data signal in accordance with another exemplary aspect of the present disclosure.

FIG. 8 is a graph of a processed data signal in accordance with yet another exemplary aspect of the present disclosure.

FIG. 9 is a schematic view of a propulsion system in accordance with another exemplary embodiment of the present disclosure.

FIG. 10 is a schematic view of a propulsion system in accordance with yet another exemplary embodiment of the present disclosure.

FIG. 11 is a flow diagram of a method of operating a propulsion system in accordance with an exemplary aspect of the present disclosure.

FIG. 12 is a schematic view of a controller in accordance with an exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows. However, the terms “upstream” and “downstream” as used herein may also refer to a flow of electricity.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The present disclosure is generally related to a propulsion system that includes a gas turbine engine and an electric assembly. Accordingly, the propulsion system may be referred to as a hybrid-electric propulsion system. The gas turbine engine includes a turbomachine, and the turbomachine includes a compressor, a turbine, and a shaft rotatable with the turbine. Further, the electric assembly includes an electric machine rotatable with the shaft and a control system in electric communication with the electric machine.

The control system is configured to receive data from the electric machine indicative of an electric power flow to or from the electric machine and determine health information of the gas turbine engine in response to the received data. The data may be received by a converter assembly of the control system and provided to a system controller of the control system. A signal indicative of the data may be processed by the converter assembly or the control system and compared to a library of processed signal patterns to determine the health information.

Such a control system may allow for high bandwidth feedback from the hybrid electric architecture to determine the health information, such as engine failures and/or significant changes in engine health, and further may allow for corrective actions to be instructed and initiated either via the electric machine or through a primary engine control (e.g., FADEC).

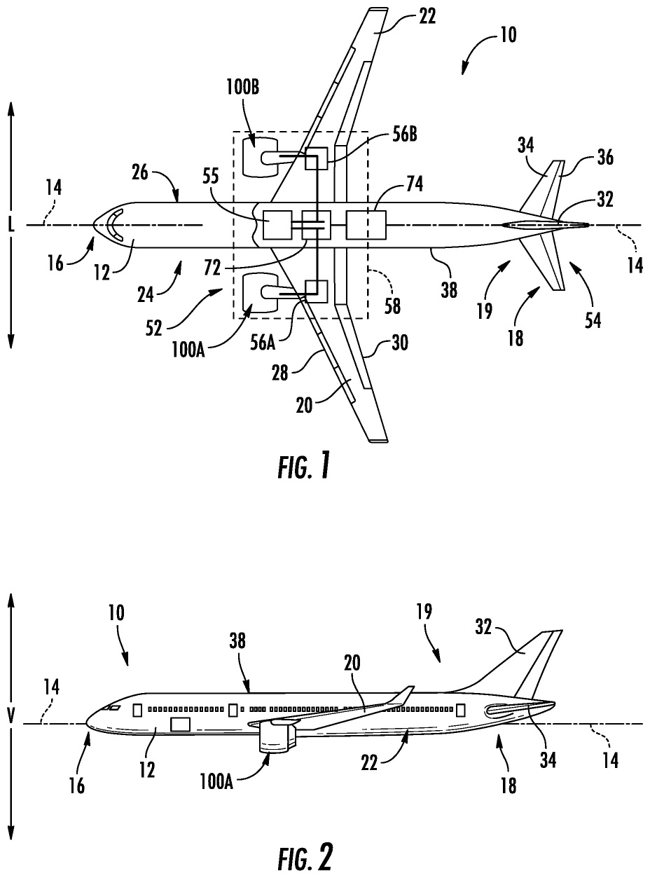

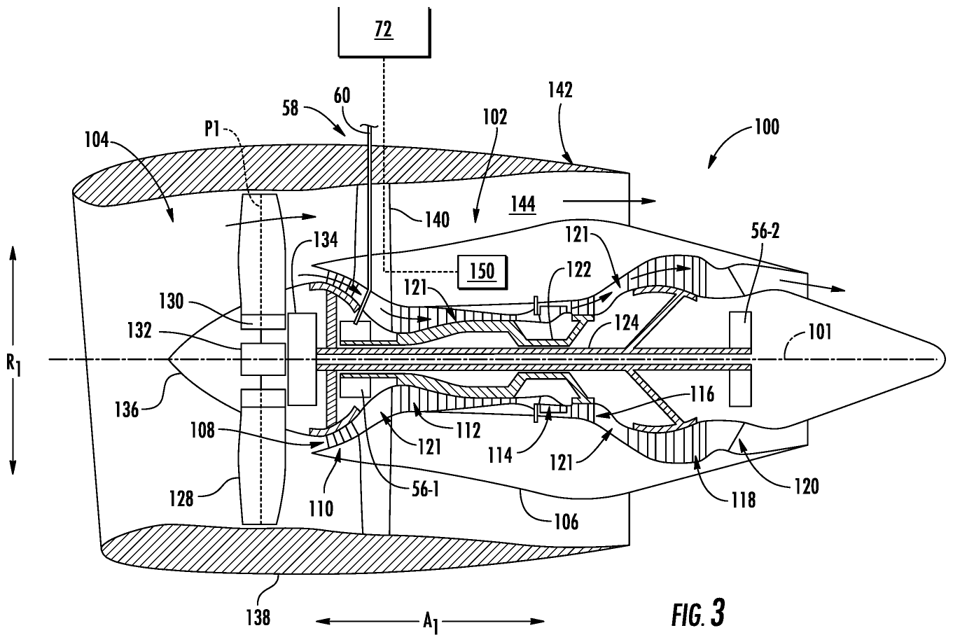

Referring now to the drawings, wherein identical numerals indicate the same elements throughout the figures, FIG. 1 provides a top, schematic view of an aircraft 10 having a hybrid-electric propulsion system 50 in accordance with still another exemplary embodiment of the present disclosure, and FIG. 2 provides a side, schematic view of the exemplary aircraft of FIG. 1. In particular, FIGS. 1 and 2 depict an aircraft 10, the aircraft 10 defining a longitudinal centerline 14 that extends therethrough, a lateral direction L, a forward end 16, and an aft end 18. The aircraft 10 includes a fuselage 12, an empennage 19, a first wing 20, and a second wing 22. The first and second wings 20, 22 each extend laterally outward with respect to the longitudinal centerline 14. The first wing 20 and a portion of the fuselage 12 together define a first side 24 of the aircraft 10, and the second wing 22 and another portion of the fuselage 12 together define a second side 26 of the aircraft 10. For the embodiment depicted, the first side 24 of the aircraft 10 is configured as the port side of the aircraft 10, and the second side 26 of the aircraft 10 is configured as the starboard side of the aircraft 10.

Each of the wings 20, 22 for the exemplary embodiment depicted includes one or more leading edge flaps 28 and one or more trailing edge flaps 30. The aircraft 10 further includes, or rather, the empennage 19 of the aircraft 10 includes, a vertical stabilizer 32 having a rudder flap (not shown) for yaw control, and a pair of horizontal stabilizers 34, each having an elevator flap 36 for pitch control. The fuselage 12 additionally includes an outer surface or skin 38. It should be appreciated however, that in other exemplary embodiments of the present disclosure, the aircraft 10 may additionally or alternatively include any other suitable configuration. For example, in other embodiments, the aircraft 10 may include any other configuration of stabilizer.

The exemplary aircraft 10 of FIG. 1 additionally includes a hybrid-electric propulsion system 50 having a first gas turbine engine 100A, a second gas turbine engine 100B, and an electric energy storage unit 55. For the embodiment depicted, the first gas turbine engine 100A and second gas turbine engine 100B are each configured in an underwing-mounted configuration.

Referring now also to FIG. 3, a schematic, cross-sectional view is provided of a gas turbine engine 100. The first and second gas turbine engines 100A, 100B depicted in FIGS. 1 and 2 may be configured in a similar manner as the exemplary engine 100 of FIG. 3.

The gas turbine engine 100 of FIG. 3 is more particularly configured as a turbofan engine 100, including a turbomachine 102 and a fan 104. As shown in FIG. 3, the turbofan 100 defines an axial direction A1 (extending parallel to a longitudinal axis 101 provided for reference) and a radial direction R1. As stated, the turbofan 100 includes the fan 104 and the turbomachine 102 disposed downstream from the fan 104.

The exemplary turbomachine 102 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a first, high pressure (HP) turbine 116 and a second, low pressure (LP) turbine 118; and a jet exhaust nozzle section 120. The compressor section, combustion section 114, and turbine section together define at least in part a core air flowpath 121.

The exemplary turbomachine 102 of the turbofan 100 additionally includes one or more shafts rotatable with at least a portion of the turbine section and, for the embodiment depicted, at least a portion of the compressor section. More particularly, for the embodiment depicted, the turbofan 100 includes a high pressure (HP) shaft or spool 122, which drivingly connects the HP turbine 116 to the HP compressor 112. Additionally, the exemplary turbofan 100 includes a low pressure (LP) shaft or spool 124, which drivingly connects the LP turbine 118 to the LP compressor 110.

Further, the exemplary fan 104 depicted is configured as a variable pitch fan having a plurality of fan blades 128 coupled to a disk 130 in a spaced apart manner. The fan blades 128 extend outwardly from disk 130 generally along the radial direction R1. Each fan blade 128 is rotatable relative to the disk 130 about a respective pitch axis P1 by virtue of the fan blades 128 being operatively coupled to a suitable actuation member 132 configured to collectively vary the pitch of the fan blades 128. The fan 104 is mechanically coupled to the LP shaft 124, such that the fan 104 is mechanically driven by the second, LP turbine 118. More particularly, the fan 104, including the fan blades 128, disk 130, and actuation member 132, is mechanically coupled to the LP shaft 124 through a power gearbox 134, and is rotatable about the longitudinal axis 101 by the LP shaft 124 across the power gear box 134. The power gear box 134 includes a plurality of gears for stepping down the rotational speed of the LP shaft 124 to a more efficient rotational fan speed. Accordingly, the fan 104 is powered by an LP system (including the LP turbine 118) of the turbomachine 102.

Referring still to the exemplary embodiment of FIG. 3, the disk 130 is covered by rotatable front hub 136 aerodynamically contoured to promote an airflow through the plurality of fan blades 128. Additionally, the turbofan 100 includes an annular fan casing or outer nacelle 138 that circumferentially surrounds the fan 104 and/or at least a portion of the turbomachine 102. Accordingly, the exemplary turbofan 100 depicted may be referred to as a “ducted” turbofan engine. Moreover, the nacelle 138 is supported relative to the turbomachine 102 by a plurality of circumferentially-spaced outlet guide vanes 140. A downstream section 142 of the nacelle 138 extends over an outer portion of the turbomachine 102 so as to define a bypass airflow passage 144 therebetween.

Referring still to FIG. 3, the hybrid-electric propulsion system 50 additionally includes an electric machine, which for the embodiment depicted is configured as an electric motor/generator 56. The electric motor/generator 56 is, for the embodiment depicted, positioned within the turbomachine 102 of the turbofan engine 100 and is in mechanical communication with one of the shafts of the turbofan engine 100. More specifically, for the embodiment depicted, the electric motor/generator 56 is a first electric motor/generator 56-1, and is positioned inward of the core air flowpath 121, driven by the first, HP turbine 116 through the HP shaft 122. The first electric motor/generator 56-1 is configured to convert mechanical power of the HP shaft 122 to electric power during certain operations, and further is configured to convert electrical power to mechanical power in other operations. Accordingly, the first electric motor/generator 56-1 may be powered by the HP system (including the HP turbine 116) of the turbomachine 102 during certain operations and may power the HP system during other operations.

Further, for the embodiment depicted in the example of FIG. 3, the hybrid-electric propulsion system 50 additionally includes a second electric motor/generator 56-2. The second electric motor/generator 56-2 is configured to convert mechanical power of the LP shaft 124 to electric power during certain operations, and further is configured to convert electrical power to mechanical power in other operations. Accordingly, the second electric motor/generator 56-2 may be powered by the LP system (including the LP turbine 118) of the turbomachine 102 during certain operations and may power the LP system during other operations.

Notably, the electric motor/generators 56-1, 56-2 may be relatively powerful motor/generators. For example, during certain operations, the motor/generators 56-1, 56-2 may be configured to generate at least about fifty kilowatts of electrical power or at least about sixty-five horsepower of mechanical power and up to, e.g., three hundred horsepower of mechanical power. In other embodiments, however, the electric motor/generators 56-1, 56-2 may generate other amounts of power.

It should be appreciated, however, that in other exemplary embodiments, the electric motor/generators 56-1, 56-2 may instead be positioned at any other suitable location within the turbomachine 102 or elsewhere, and may be, e.g., powered in any other suitable manner. For example, the first electric motor/generator 56-1 may be, in other embodiments, mounted coaxially with the HP shaft 122 within the turbine section, or alternatively may be offset from the HP shaft 122 and driven through a suitable gear train. Similarly, the second electric motor/generator 56-2 may be, in other embodiments, mounted coaxially with the LP shaft 124 within the compressor section, or alternatively may be offset from the LP shaft 124 and driven through a gear train. Additionally, or alternatively, still, in other embodiments, the hybrid-electric propulsion system 50 may not include both the first and second electric motor/generators 56-1, 56-2, and, instead, may only include one of such electric motor/generators 56-1, 56-2.

It should further be appreciated that the exemplary turbofan engine 100 depicted in FIG. 3 may, in other exemplary embodiments, have other configuration. For example, in other exemplary embodiments, the fan 104 may not be a variable pitch fan, and further, in other exemplary embodiments, the LP shaft 124 may be directly mechanically coupled to the fan 104 (i.e., the turbofan engine 100 may not include the gearbox 134). Further, it should be appreciated that in other exemplary embodiments, the first propulsor 52 may include any other suitable type of engine. For example, in other embodiments, the turbofan engine 100 may instead be configured as a turboprop engine or an unducted turbofan engine. Additionally, in still other embodiments, the turbofan engine 100 may instead be configured as any other suitable combustion engine for driving the electric motor/generators 56-1, 56-2. For example, in other embodiments, the turbofan engine may be configured as a turboshaft engine, or any other suitable combustion engine (such as an unducted, open rotor engine).

Referring still to FIGS. 1 and 2, the turbofan engine 100 further includes an engine controller 150, and, although not depicted, one or more sensors. The engine controller 150 may be a full authority digital engine control system, also referred to as a FADEC. The engine controller 150 of the turbofan engine 100 may be configured to control operation of, e.g., the actuation member 132, a fuel delivery system to the combustion section 114 (not shown), etc. Additionally, the engine controller 150 may be operably connected to the one or more sensors to receive data from the sensors and determine various operational parameters of the turbofan engine 100. For example, the engine controller 150 may determine one or more of an exhaust gas temperature, a rotational speed of the core (i.e., a rotational speed of the HP system), a compressor discharge temperature, etc. Further, referring back also to FIG. 1, the engine controller 150 of the turbofan engine 100 is operably connected to the controller 72 of the hybrid-electric propulsion system 50. Moreover, as will be appreciated, the controller 72 may further be operably connected to one or more of the first and second gas turbine engines 100A, 100B, the energy storage unit 55, etc. through a suitable wired or wireless communication system (depicted in phantom).

Referring back particularly to FIGS. 1 and 2, an electrical system of the hybrid-electric propulsion system 50 includes one or more electric machines (e.g., electric machine 56A, depicted schematically) mechanically coupled to the first gas turbine engine 100A and one or more electric machines (e.g., electric machine 56B, depicted schematically) mechanically coupled to the second gas turbine engine 100B. Although depicted schematically outside the respective gas turbine engines 100A, 100B, in certain embodiments, the electric motor/generators 56A, 56B may be positioned within a respective one of the gas turbine engines 100A, 100B (see, e.g., FIG. 3). Further, although a single electric motor/generator is depicted with each gas turbine engine 100A, 100B, in certain embodiments, a plurality of electric motor/generators 56A, 56B may be provided for each (e.g., electric motor/generators 56A-1, 56A-2 with gas turbine engine 100A, electric motor/generators 56B-1, 56B-2 with gas turbine engine 100B).

Moreover, as briefly mentioned above with reference to FIG. 3, for the embodiment of FIGS. 1 and 2 the hybrid-electric propulsion system 50 further includes a control system having a controller 72. As will be appreciated, the energy storage unit 55 may be configured, in certain operating conditions, to receive electrical power from one or both of the first electric motor/generator 56A and the second electric motor/generator 56B, and may further be configured in certain operating conditions to provide stored electrical power to one or both of the first electric motor/generator 56A and the second electric motor/generator 56B. Moreover, the controller 72 is operably connected to turbofan engines 100A, 100B, electric motor/generators 56A, 56B, and energy storage unit 55 to, e.g., control operations of the hybrid-electric propulsion system 50 and selectively electrically connect components of the hybrid-electric propulsion system 50 during the various operating conditions.

Further, the controller 72 may be in communication with one or more aircraft controllers for receiving data indicative of an aircraft need for electrical power, and may in response provide electrical power from one or more of the electric motor/generators 56A, 56B and the energy storage unit 55 to an aircraft load 74.

It should be appreciated, however, that in still other exemplary embodiments of the present disclosure, any other suitable aircraft 10 may be provided having a hybrid-electric propulsion system 50 configured in any other suitable manner. For example, in other embodiments, the turbofan engines 100A, 100B may each be configured as any other suitable combustion engine (e.g., turboprop engine, unducted turbofan engine, turboshaft engine, turbojet engine, etc.), and may be mounted at any other suitable location.

Moreover, it will be appreciated that in at least certain exemplary aspects of the present disclosure an electric assembly 224 (e.g., including an electric machine and a control system 230) operable with a propulsion system of the present disclosure may be utilized to determine health information of a gas turbine engine 202.

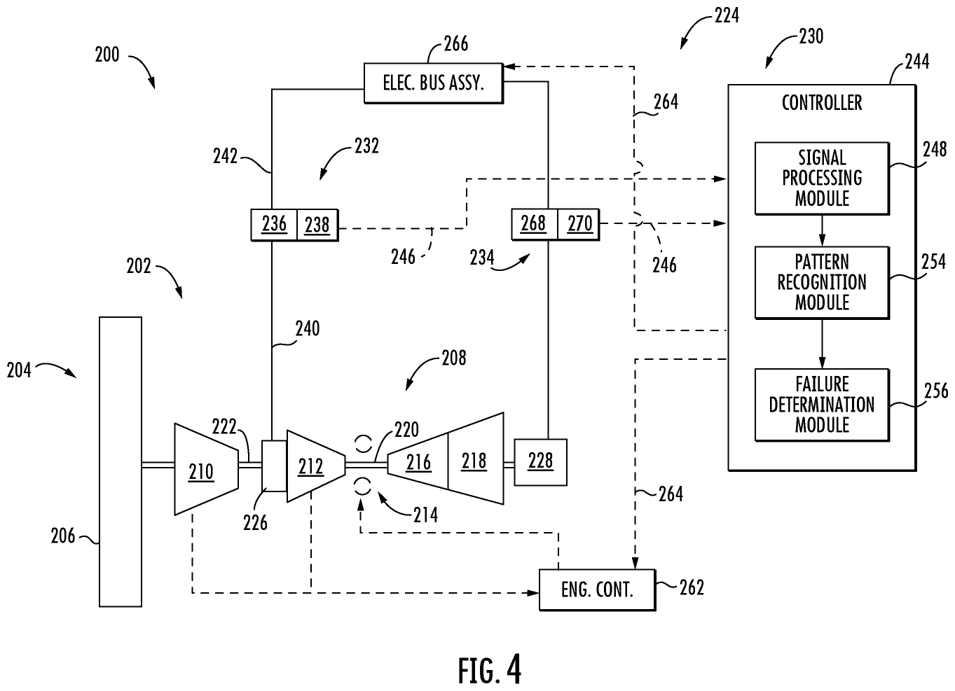

In particular, referring now to FIG. 4, a propulsion system 200 in accordance with an exemplary aspect of the present disclosure is provided. In at least certain exemplary aspects, the propulsion system 200 of FIG. 4 may be configured in a similar manner as the exemplary propulsion system 50 described above with reference to, e.g., FIGS. 1 through 3.

For example, the exemplary propulsion system 200 of FIG. 4 generally includes an aeronautical gas turbine engine 202, which may be configured in a similar manner as the exemplary turbofan engine 100 of FIG. 3. For example, as is depicted schematically, the aeronautical gas turbine engine 202 includes a fan section 204 having a fan 206 and a turbomachine 208. The turbomachine 208 generally includes a compressor section having an LP compressor 210 and an HP compressor 212, a combustion section 214, and a turbine section having an HP turbine 216 and an LP turbine 218. The turbomachine 208 further includes an HP shaft 220 rotatable with the HP compressor 212 and the HP turbine 216 and an LP shaft 222 rotatable with the LP compressor 210 and the LP turbine 218. The LP shaft 222 may further drive the fan 206 of the fan section 204.

Moreover, the exemplary propulsion system 200 depicted includes an electric assembly 224. The electric assembly 224 includes an electric machine rotatable with a shaft of the turbomachine 208. In particular, the electric machine is a first electric machine 226 rotatable with a first shaft, or rather then HP shaft 220, of the turbomachine 208, and the electric assembly 224 further includes a second electric machine 228 rotatable with a second shaft, or rather the LP shaft 222, of the turbomachine 208. The first electric machine 226 thus may be referred to as an HP electric machine and the second electric machine 228 thus may be referred to as an LP electric machine.

The electric assembly 224 further includes a control system 230 in electric communication with the electric machine, and more specifically, in electric communication with the first electric machine 226 and the second electric machine 228. As will be explained in more detail below, the control system 230 is configured to receive data from the first electric machine 226, from the second electric machine 228, or both. The received data may be indicative of an electric power flow to or from the first electric machine 226, the second electric machine 228, or both. The control system 230 is further configured to determine health information of the gas turbine engine 202 in response to the received data.

As will be appreciated from the disclosure herein, the health information may be an indication of a failure condition or a failure event. For example, the health information may be an indication of a bird strike, a compressor stall, a flameout condition, a blade out condition, or the like. In each of these cases, the power flow to or from the electric machines 226, 228 may be affected by the condition of the gas turbine engine. For example, in the event of a bird strike, a rotor that is rotatable with a fan (which strikes one or more birds) may exhibit changes in rotational speeds as a result, which affect the power flow to or from the electric machines 226, 228. Similarly, in the event of a compressor stall, a rotor that is rotatable with the affected rotor may exhibit changes in rotational speeds as a result, which again affect the power flow to or from the electric machines 226, 228. In such a manner, it will be appreciated that the received data may be indicative of an electric power flow to or from the first electric machine 226, the second electric machine 228, or both may be a proxy for changes in rotational speeds of one or more components rotatable with the rotors of the electric machines 226, 228.

Referring still to FIG. 4, it will be appreciated that the control system 230 includes a converter assembly operable with the electric machine to condition the electric power flow to or from the electric machine. More specifically, the control system 230 includes a first converter assembly 232 operable with the first electric machine 226 to condition the electric power flow to or from the first electric machine 226, and further includes a second converter assembly 234 operable with the second electric machine 228 to condition the electric power flow to or from the second electric machine 228.

The first converter assembly 232 generally includes a first plurality of switches 236 and a first converter controller 238. The first plurality of switches 236 may be operable to convert electric power from an alternating current (AC) electric power to a direct current (DC) electric power and vice versa. For example, the first plurality of switches 236 may be operable to convert AC electric power generated by the first electric machine 226 and provided to the first converter assembly 232 through electric line(s) 240 to a DC power output through electric line(s) 242; may be operable to convert a DC power input provided to the first converter assembly 232 through electric line(s) 242 to AC power output provided to the first electric machine 226 through electric line(s) 240; or both.

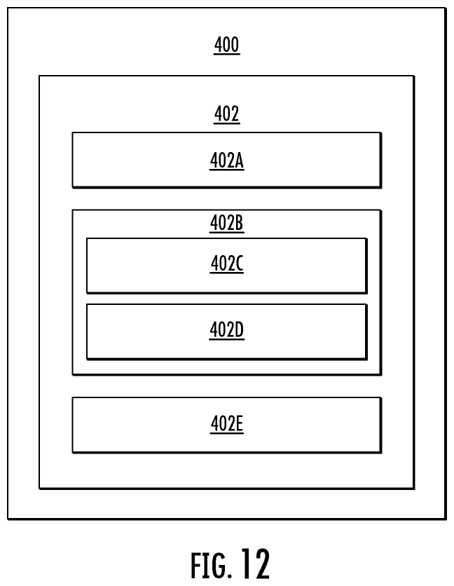

The first converter controller 238 may control operation of the first plurality of switches 236, e.g., to achieve the desired power conversion. The first converter controller 238 may include one or more sensors to sense data indicative of a power (e.g., current, voltage, or power) through the line(s) 240, 242, through the first converter assembly 232, or a combination thereof to, e.g., assist in making control decisions. The first converter controller 238 may be configured in a similar manner as the controller 400 described below with reference to FIG. 12

In such a manner, it will be appreciated that in the exemplary embodiment depicted, the control system 230 is configured to receive the data from the first electric machine 226 indicative of the electric power flow to or from the first electric machine 226 with the first converter assembly 232, and more specifically, with the first converter controller 238.

In at least certain exemplary aspects, the data received by the control system 230, and, more specifically, by the first converter controller 238 may be data indicative of a current of electric power provided to or generated by the first electric machine 226, a voltage of electric power provided to or generated by the first electric machine 226, a rotational speed of the first electric machine 226, a torque applied to or by the first electric machine 226, or some combination thereof.

Referring still to FIG. 4, the exemplary control system 230 depicted further includes a system controller 244. The system controller 244 may be a stand-a-lone controller, may be incorporated into one or more other controllers of the electric assembly 224 or the propulsion system 200, or may be formed of a plurality of separate controllers. The system controller 244 may be configured in a similar manner as the controller 400 described below with reference to FIG. 12.

The first converter controller 238 is configured to provide, and the system controller 244 is configured to receive, a signal 246 indicative of the received data indicative of the power flow to or from the first electric machine 226. In the embodiment depicted, it will be appreciated that the signal 246 provided from the first converter controller 238 to the system controller 244 is a raw data signal. As will be explained, the system controller 244 is configured to process the signal 246 to generate a processed data signal and further to analyze the processed data signal and determine health information of the gas turbine engine 202.

It will be appreciated that as used herein, the term “raw data signal” refers to an unaltered electrical output from the electric machine. The unaltered electrical output may be characterized by a time-domain representation and may encompass all inherent fluctuations, noise, and other characteristics intrinsic to the electric machine's operation.

As used herein, the term “processed data signal” refers to an electrical output derived from the raw data signal after undergoing analytical and/or computational procedures to extract, enhance, and/or isolate specific information or characteristics. The processed data signal may be characterized by a frequency domain representation, e.g., through Fourier transform or analogous mathematical operations.

In particular, the system controller 244 includes a signal processing module 248 configured to receive the raw data signal from the first converter assembly 232 (signal 246 in the embodiment depicted). The signal processing module 248 may generally receive the raw data signal and process the raw data signal to obtain the processed that a signal. The processing may include utilizing a transform or other deciphering model to extract a signal that, e.g., more easily identifies health data of the gas turbine engine 202.

It will be appreciated that as used herein, the term “module” refers to a distinct functional unit or component within a controller or control system that is devised to perform a specific subset of tasks related to the management and operation of a system as a whole. A module may consist of hardware elements, software routines, or a combination of both, and is configured to integrate and cooperate with other modules within the controller or control system to facilitate desired processing and operational functions. The module may be responsible for various tasks, including but not limited to, receiving input signals, executing predetermined algorithms, controlling machine parameters, and generating output signals to influence the behavior or performance of the electric machine in a coordinated manner.

In particular, for the exemplary aspect depicted, the signal processing module 248 may utilize a Fourier transform model to process the raw data signal into the processed data signal. In such a manner, the signal processing module 248 may transform the raw data signal (e.g., in a time domain signal) into the processed data signal in the form of a Fourier frequency spectrum signal (e.g., in a frequency domain signal).

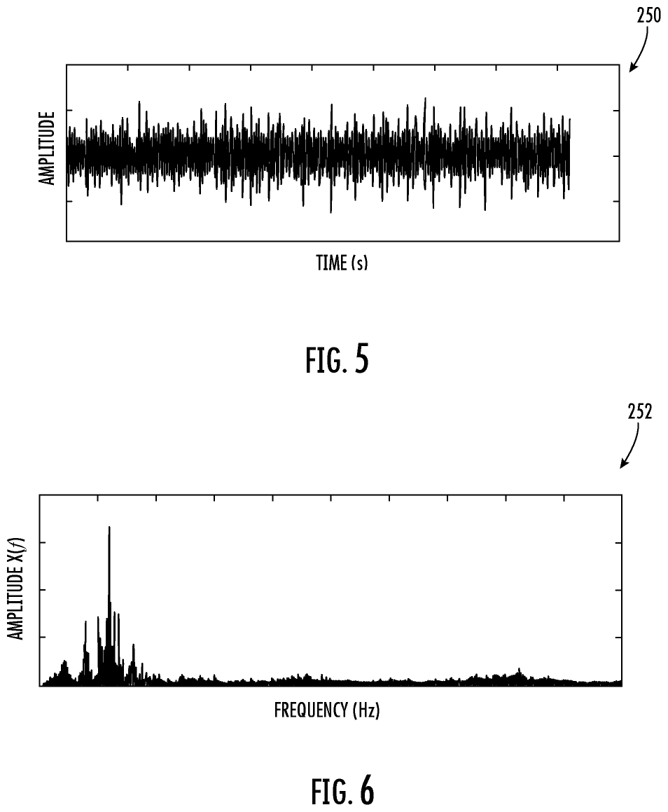

For example, referring briefly to FIG. 5, FIG. 5 provides a graph 250 depicting a raw data signal in accordance with an exemplary aspect of the present disclosure, with the gas turbine engine 202 operating in a nominal manner (e.g., not in a failure condition or under a failure event). The raw data signal of FIG. 5 may be the signal 246 provided from the first converter controller 238 to the system controller 244 in the embodiment of FIG. 4. The signal in the graph 250 of FIG. 5 is represented in the time domain (along an x-axis in units of time). Referring now briefly to FIG. 6, FIG. 6 provides a graph 252 depicting a processed data signal in accordance with an exemplary aspect of the present disclosure. The processed data signal in the graph 252 may be the output of the signal processing module 248 upon receiving the signal from the graph 250 in FIG. 5. The signal in the graph 252 of FIG. 6 is represented in the frequency domain (along an x-axis in units of frequency). In particular, the processed data signal of FIG. 6 is a Fourier frequency spectrum signal corresponding to the raw data signal in FIG. 5.

Referring back to FIG. 4, as briefly noted above, the control system 230 is configured to determine health information of the gas turbine engine 202 in response to the received data. In the exemplary aspect depicted in FIG. 4, the system controller 244 is configured to determine the health information using a pattern recognition analysis. In particular, the system controller 244 includes a pattern recognition module 254 and a failure determination module 256. The pattern recognition module 254 is configured to receive the processed data signal from the signal processing module 248. The pattern recognition module 254 may compare the processed data signal to one or more signal patterns associated with processed data signals during one or more failure conditions and/or failure events. The pattern recognition module 254 may determine the signal pattern(s) most closely related to processed data signal received, and may provide such information to the failure determination module 256. In response to receiving such information from the pattern recognition module 254, the failure determination module 256 may determine the health information of the gas turbine engine 202, which may be that the gas turbine engine 202 is experiencing a failure condition or failure event.

In such a manner, it will be appreciated that the pattern recognition module 254 may include a library of signal patterns associated with processed data signals during various operations of the gas turbine engine 202, including during one or more failure conditions and/or failure events of the gas turbine engine 202. The signal patterns may include signal patterns for nominal operations of the gas turbine engine 202 during various flight conditions (e.g., taxi, takeoff, climb, cruise, descent), failure condition (e.g., compressor stall, flameout), and/or failure events (e.g., bird strike, blade out, shaft sheer).

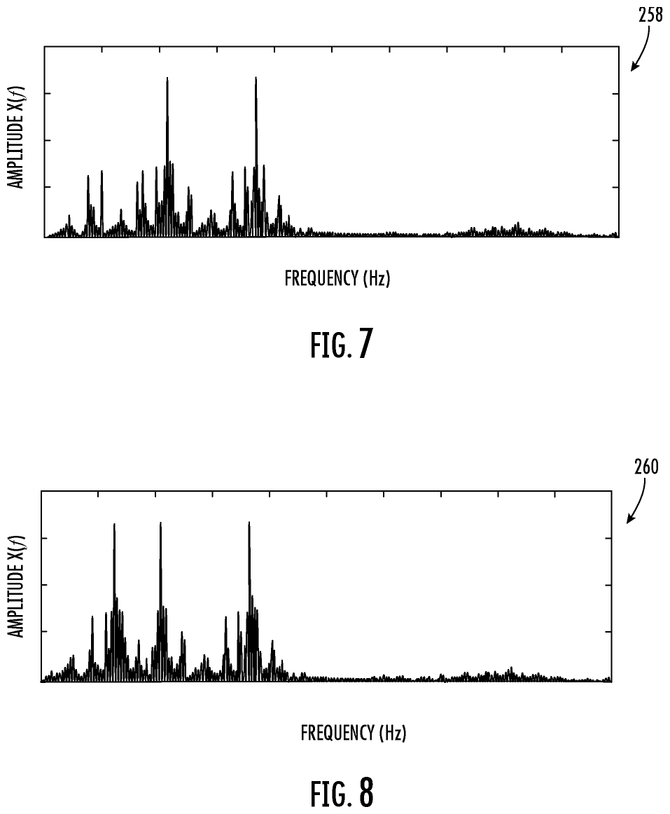

For example, referring now to FIGS. 7 and 8, graphs 258, 260 are provided of two additional processed data signals (similar to the processed data signal in the graph 252 of FIG. 6). However, the processed data signals in the graphs 258, 260 of FIGS. 7 and 8 are associated with two different failure conditions or failure events for the gas turbine engine 202. The pattern recognition module 254 in FIG. 4 may, as noted, include a library of exemplary signal patterns associated with processed data signals during various operations of the gas turbine engine. The processed data signals in the graphs 258, 260 of FIGS. 7 and 8 may be compared to the signal patterns in the library of signal patterns to determine a likely failure condition or failure event. Such information may, as noted above, be provided to the failure determination module 256 to determine the health information of the gas turbine engine 202.

As will be appreciated from the graphs 258, 260 of FIGS. 7 and 8, different failure conditions and failure events may have unique signal patterns. Accordingly, the above control system 230 may not only determine that a failure event or failure condition has occurred, but may also determine which failure event or condition has occurred.

For example, in one exemplary scenario, the gas turbine engine may be operating in a climb operational mode. One or both of the electric machines 226, 228 may be adding power to the HP shaft 220 or LP shaft 222, respectively, or extracting power from the HP shaft 220 or LP shaft 222, respectively, in an anticipated and commanded manner. The first and second converter controllers 238, 270 may provide signals 246 to the controller 244, and more specifically to the signal processing module 248 of the controller 244. The signals 246 may be raw data signals indicating power flow to or from the electric machines 226, 228. The signal processing module 248 may process the signals 246 (e.g., convert to a frequency domain representation, e.g., through Fourier transform or analogous mathematical operations) and provide the processed signals to the pattern recognition module 254. The pattern recognition module 254 may, e.g., compare the processed data signals received to the library of signal patterns associated with signal patterns of processed data signals during various operations of the gas turbine engine to determine the engine is in the climb operational mode.

While operating during the climb operational mode, the gas turbine engine may ingest one or more birds (a “bird strike”), in which case the rotating components of the engine may be affected by the sudden resistance created by contacting the one or more birds. The electric machines 226, 228 rotatable with the rotating components may accordingly experience changes in power flow to/from the electric machines 226, 228 as a result the rotating components being affected by the contact with the one or more birds. During this event, the first and second converter controllers 238, 270 may continue to provide signals 246 to the controller 244, and more specifically to the signal processing module 248 of the controller 244. The signals 246 may be raw data signals indicating power flow to or from the electric machines 226, 228 during this event. The signal processing module 248 may process the signals 246 and provide the processed signals to the pattern recognition module 254. The pattern recognition module 254 may, e.g., compare the processed data signals received to the library of signal patterns associated with signal patterns of processed data signals during various operations of the gas turbine engine to determine the engine has ingested one or more birds. In particular, the processed data signals received by the pattern recognition module 254 during this event may match or be similar to a pattern of processed data signals associated with a bird strike to indicate that the engine has ingested one or more birds.

Referring again back to FIG. 4, in response to determining the health information, which may be a failure condition or failure event, the control system 230 may be configured to instruct a responsive action to be taken. The responsive action may be a corrective action (e.g., to correct compressor stall), or may be a mitigation action (e.g., to prevent excessive vibration in a bladeout event).

In particular, it will be appreciated that the exemplary gas turbine engine 202 further includes an engine controller 262, which as is noted above, may be a full authority digital engine control or FADEC. The system controller 244 of the control system 230 may provide one or more responsive action signals 264 to the engine controller 262.

Additionally, or alternatively, it will be appreciated that the exemplary electric assembly 224 of the propulsion system 200 depicted in FIG. 4 further includes an electric bus assembly 266. The electric bus assembly 266 may be an electric distribution bus of the gas turbine engine 202 and/or propulsion system 200. In such a manner, the electric bus assembly 266 may be in electric communication with one or more power sources, one or more power sinks, one or more controllers, etc. In such a manner, the system controller 244 may provide one or more responsive signals 264 to the electric bus assembly 266 to modify an electric power flow to or from the first electric machine 226, e.g., based on the type of failure condition or failure event determined.

Referring still to FIG. 4, as noted above, the electric assembly 224 further includes the second electric machine 228 and second converter assembly 234. The second electric machine 228 and second converter assembly 234 may be configured in a similar manner as the first electric machine 226 and first converter assembly 232. For example, the second converter assembly 234 is in communication with the second electric machine 228 and is operable with the second electric machine 228 to condition the electric power flow to or from the second electric machine 228. The second converter assembly 234 generally includes a second plurality of switches 268 and a second converter controller 270. The second converter controller 270 may be operable with the system controller 244 to similarly to determine health information of the gas turbine engine 202 (e.g., a failure condition or failure event) in response to data received from the second electric machine 228. Notably, the second electric machine 228 is similarly in electric communication with the electric bus assembly 266 through the second converter assembly 234.

Inclusion of such a configuration may allow for the propulsion system 200 to determine health information of the aeronautical gas turbine engine 202. Further, by including the system controller 244 separate form the engine controller 262 of the aeronautical gas turbine engine 202, the health information may be determined more quickly and responsive signals 264 may similarly be provided more quickly.

For example, as will be appreciated, in certain exemplary aspects, the engine controller 262 may define a first operating frequency and the system controller 244 may define a second operating frequency. The second operating frequency may be higher than the first operating frequency. More specifically, the engine controller 262 may define a first control decision frequency, and the system controller 244 may define a second control decision frequency. The second control decision frequency may be higher than the first control decision frequency. For example, in certain exemplary embodiments, the system controller 244 may operate at a frequency of at least 250 hertz (Hz), such as at least 500 Hz, such as at least 750 Hz, such as at least 1 kilohertz (kHz), such as up to 8 kHz. By contrast, the engine controller 262 may operate at a frequency less than the frequency of the system controller 244, such as less than 250 Hz, such as less than 120 Hz, such as greater than 10 Hz.

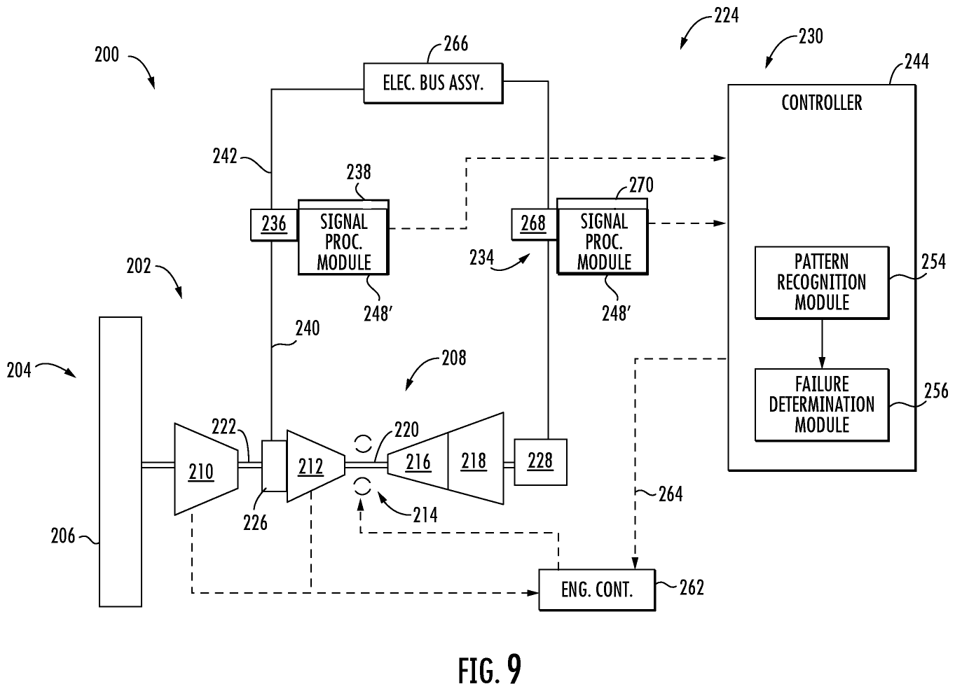

It will be appreciated, however, that in other exemplary embodiments, the propulsion system 200 may be configured in accordance with any other suitable manner. For example, referring now to FIG. 9, a schematic diagram is provided of a propulsion system 200 in accordance with another exemplary embodiment of the present disclosure. The exemplary propulsion system 200 of FIG. 9 may be configured in a similar manner as exemplary propulsion system 200 described above with reference to FIG. 4, and the same or similar numbers may refer to the same or similar parts.

For example, exemplary propulsion system 200 of FIG. 9 generally includes an aeronautical gas turbine engine 202 having a turbomachine 208 and an electric assembly 224 having an electric machine rotatable with a shaft of the turbomachine 208. The electric assembly 224 further includes a control system 230 having a converter assembly operable with the electric machine.

More specifically, the electric machine is a first electric machine 226 and the converter assembly is a first converter assembly 232. The first converter simply generally includes a first plurality of switches 236 and a first converter controller 238. Notably, however, for the embodiment depicted, the first converter controller 238 includes a signal processing module 248′ which may operate in a similar manner as exemplary signal processing module 248 described above with reference to FIG. 4. Accordingly, for the exemplary embodiment of FIG. 9, the first converter assembly 232 is configured to receive data indicative of an electric power flow to or from the first electric machine 226 and, with the signal processing module 248 of the first converter controller 238, process a raw data signal associated with the data indicative of the electric power flow to or from the first electric machine 226 into a processed data signal. The first converter assembly 232 is configured to provide the processed data signal (signal 246) to a system controller 244 of the control system 230. The system controller 244 may use the processed data signal to determine the health information of the gas turbine engine 202 (e.g., a failure condition or failure event) in a similar manner as the system controller 244 described above with reference to FIG. 4.

As will further be appreciated from the view of FIG. 9, the control system 230 further includes a second converter assembly 234 operable with a second electric machine 228 of the electric assembly 224. The second converter assembly 234 similarly includes a second plurality of switches 268 and a second converter controller 270. The second converter controller 270 may be operable in a similar manner as the first converter controller 238 to provide a processed data signal (e.g., signal 246) to the system controller 244.

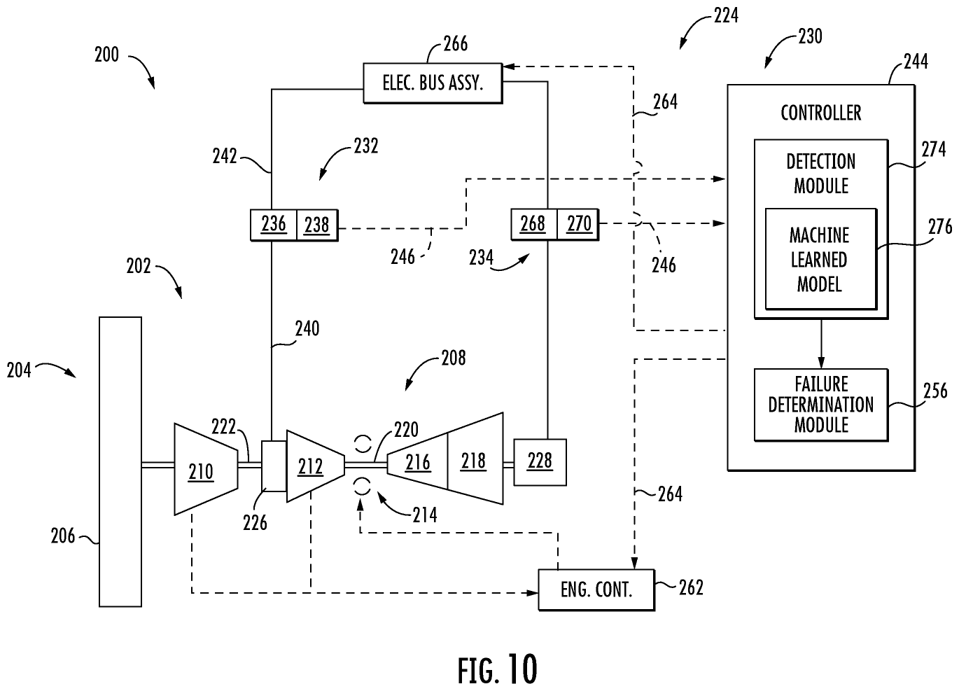

Moreover, in still other exemplary embodiments, still other configurations may be provided. For example, referring now to FIG. 10, a schematic diagram is provided of a propulsion system 200 in accordance with yet another exemplary embodiment of the present disclosure. The exemplary propulsion system 200 of FIG. 10 may be configured in a similar manner as exemplary propulsion system 200 described above with reference to FIG. 4, and the same or similar numbers may refer to the same or similar part.

For example, in the embodiment of FIG. 10, the propulsion system 200 generally includes an electric assembly 224 having a control system 230, with the control system 230 including a system controller 244. The system controller 244 may be configured to receive a raw data signal from a first converter assembly 232 (signal 246) operable with a first electric machine 226 rotatable with a shaft of a turbomachine 208 of an aeronautical gas turbine engine 202. The system controller 244 may be configured in a similar manner as exemplary system controller 244 described above the reference to FIG. 4.

However, for the embodiment of FIG. 10, the system controller 244 includes a detection module 274, with the detection module 274 including a machine learned model 276. In the embodiment shown, the machine learned model 276 of the detection module 274 may be configured to receive a raw data signal from, e.g., the first converter assembly 232 (signal 246), and using the machine learned model 276 may associate health information of the gas turbine engine 202 (e.g., a failure condition or failure event). Such information may be provided to a failure determination module 256.

The inclusion of such a configuration may result in a reduced amount of processing required by the system controller 244.

It will be appreciated that as used herein, the term “machine learned model” refers to a computational model developed through the application of machine learning algorithms to analyze and interpret data signals originating from an electric machine. This machine learned model may be designed to autonomously adapt and improve its analytical capabilities through exposure to additional data over time. Utilizing statistical and mathematical techniques, the machine learned model may process data signals to extract significant patterns and correlations, which may subsequently be employed to ascertain the health information of the gas turbine engine. This may involve identifying anomalies, predicting or identifying failure conditions or failure events, etc. based on the observed patterns within the data signals. The machine learned model may be trained using supervised learning, unsupervised learning, semi-supervised learning, reinforcement learning, transfer learning, ensemble learning, deep learning, or combination thereof.

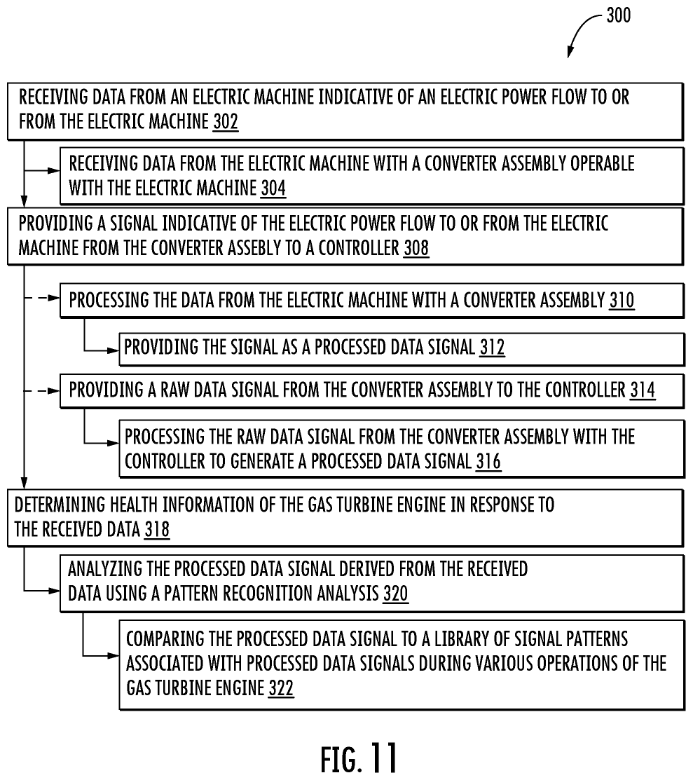

Referring now to FIG. 11, a flow diagram of a method 300 of operating a propulsion system in accordance with an exemplary aspect of the present disclosure is provided. The method 300 may be operable with one or more exemplary embodiments described above with reference to FIGS. 1 through 10.

For the exemplary aspect of FIG. 11, the method 300 includes at (302) receiving data from an electric machine indicative of an electric power flow to or from the electric machine. The electric machine is rotatable with a shaft of a turbomachine of an aeronautical gas turbine engine. In the exemplary aspect shown, receiving data from the electric machine at (302) includes at (304) receiving data from the electric machine with a converter assembly operable with the electric machine.

Referring still to FIG. 11, the method 300 further includes at (308) providing a signal indicative of the electric power flow to or from the electric machine from the converter assembly to a controller.

In one exemplary aspect, providing the signal indicative of the electric power flow to or from the electric machine from the converter assembly to the controller at (308) includes at (310) processing the data from the electric machine with the converter assembly; and at (312) providing the signal as a processed data signal.

In an alternative exemplary aspect, providing the signal indicative of the electric power flow to or from the electric machine from the converter assembly to the controller at (308) includes at (314) providing a raw data signal from the converter assembly to the controller. With such an exemplary aspect, the method 300 further includes at (316) processing the raw data signal from the converter assembly with the controller to generate a processed data signal.

Referring still to FIG. 11, the method 300 further includes at (318) determining health information of the gas turbine engine in response to the received data. In particular, for the exemplary aspect shown, determining the health information of the gas turbine engine in response to the received data at (318) includes at (320) analyzing the processed data signal derived from the received data using a pattern recognition analysis. More specifically, analyzing the processed data signal derived from the received data using the pattern recognition analysis at (320) includes, for the exemplary aspect shown, at (322) comparing the processed data signal to a library of signal patterns associated with processed data signals during various operations of the gas turbine engine.

For example, in one exemplary aspect, the method 300 may determine health information of the gas turbine engine during a failure condition, such as during a bird strike. With such an exemplary aspect, the signal provided at (308) may be indicative of a power from to or from the electric machine during the bird strike. As will be appreciated, the rotating components of the gas turbine engine rotatable with the electric machine may be affected by the contact with one or more birds, which may affect the signal. The method 300 may process the signal, e.g., at (310) or (316), and determine the gas turbine engine has experienced a bird strike at (318) by analyzing the processed signal at (320), such as by comparing the processed data signal from the electric machine during the bird strike to a library of signal patters associated with processed data signals during various operating conditions of the gas turbine engine.

Referring now to FIG. 12, a controller 400 in accordance with an exemplary aspect of the present disclosure is provided. One or more of the exemplary controllers noted above may be configured in a similar manner.

In one or more exemplary embodiments, the controller 400 depicted in FIG. 2 may be a stand-alone controller 400 for a propulsion system of the present disclosure, or alternatively, may be integrated into one or more of a controller for a gas turbine engine, a controller for an aircraft including the propulsion system, etc.

Referring particularly to the operation of the controller 400, in at least certain embodiments, the controller 400 can include one or more computing device(s) 402. The computing device(s) 402 can include one or more processor(s) 402A and one or more memory device(s) 402B. The one or more processor(s) 402A can include any suitable processing device, such as a microprocessor, microcontroller, integrated circuit, logic device, and/or other suitable processing device. The one or more memory device(s) 402B can include one or more computer-readable media, including, but not limited to, non-transitory computer-readable media, RAM, ROM, hard drives, flash drives, and/or other memory devices.

The one or more memory device(s) 402B can store information accessible by the one or more processor(s) 402A, including computer-readable instructions 402C that can be executed by the one or more processor(s) 402A. The instructions 402C can be any set of instructions that when executed by the one or more processor(s) 402A, cause the one or more processor(s) 402A to perform operations. In some embodiments, the instructions 402C can be executed by the one or more processor(s) 402A to cause the one or more processor(s) 402A to perform operations, such as any of the operations and functions for which the controller 400 and/or the computing device(s) 402 are configured, the operations of a propulsion system disclosed here, and/or any other operations or functions of the one or more computing device(s) 402. The instructions 402C can be software written in any suitable programming language or can be implemented in hardware. Additionally, and/or alternatively, the instructions 402C can be executed in logically and/or virtually separate threads on the one or more processor(s) 402A. The one or more memory device(s) 402B can further store data 402D that can be accessed by the one or more processor(s) 402A. For example, the data 402D can include data indicative of power flows, data indicative of engine/aircraft operating conditions, and/or any other data and/or information described herein.

The computing device(s) 402 can also include a network interface 402E used to communicate, for example, with the other components of the propulsion system. For example, in the embodiment depicted, as noted above, the propulsion system (including a gas turbine engine, electric machine, etc.) includes one or more sensors for sensing data indicative of one or more parameters of the gas turbine engine, the electric machine(s), etc. The controller 400 may be operably coupled to the one or more sensors through, e.g., the network interface, such that the controller 400 may receive data indicative of various operating parameters sensed by the one or more sensors during operation.

The network interface 402E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It will be appreciated that although the exemplary embodiments discussed above are related to an aeronautical vehicle, in other exemplary embodiments of the present disclosure, a propulsion system may be provided for use with any other suitable vehicles, such as land-based vehicles (in which case the propulsion system may include, e.g., an internal combustion/automotive engine).

A control system in accordance with one or more exemplary aspects of the present disclosure may allow for high bandwidth feedback from the hybrid electric architecture to determine the health information, such as engine failures and/or significant changes in engine health, and further may allow for corrective actions to be instructed and initiated either via the electric machine or through a primary engine control (e.g., FADEC). In particular, determining health information in accordance with an exemplary aspect of the present disclosure may allow for a more expedient determination of the event, and therefore for a more expedient action to be taken to correct or mitigate the event.

Further aspects are provided by the subject matter of the following clauses:

A propulsion system comprising: a gas turbine engine having a turbomachine, the turbomachine comprising a compressor, a turbine, and a shaft rotatable with the turbine; and an electric assembly comprising: an electric machine rotatable with the shaft; a control system in electric communication with the electric machine, the control system configured to receive data from the electric machine indicative of an electric power flow to or from the electric machine and determine health information of the gas turbine engine in response to the received data.

The propulsion system of any preceding clause, wherein the control system includes a converter assembly operable with the electric machine to condition the electric power flow to or from the electric machine.

The propulsion system of any preceding clause, wherein the control system is configured to receive the data with the converter assembly, wherein control system further comprises a controller configured to receive a signal indicative of the electric power flow to or from the electric machine from the converter assembly.

The propulsion system of any preceding clause, wherein the controller is further configured to process the signal indicative of the electric power flow to or from the electric machine.

The propulsion system of any preceding clause, wherein the converter assembly is further configured to process the data indicative of the electric power flow to or from the electric machine, and wherein the signal indicative of the electric power flow to or from the electric machine is a processed data signal.

The propulsion system of any preceding clause, wherein the control system is configured to determine the health information of the gas turbine engine using a pattern recognition analysis.

The propulsion system of any preceding clause, wherein the control system is configured to determine the health information of the gas turbine engine by comparing a processed data signal derived from a raw data signal to a library of signal patterns associated with processed data signals during various operations of the gas turbine engine.

The propulsion system of any preceding clause, wherein the processed data signal is derived from the raw data signal using a Fourier frequency transform.

The propulsion system of any preceding clause, wherein the control system comprises a controller having a detection module configured to determine the health information of the gas turbine engine using a machine learned model.

The propulsion system of any preceding clause, wherein the control system is further configured to instruct a responsive action to be taken in response to the determining the health information of the gas turbine engine is a failure event or failure condition.

The propulsion system of any preceding clause, the compressor is a low pressure compressor, wherein the turbine is a low pressure turbine, wherein the shaft is a low pressure shaft, wherein the turbomachine further comprises a high pressure compressor, a high pressure turbine, and a high pressure shaft rotatable with high pressure turbine, wherein the electric machine is a low pressure electric machine, and wherein the electric assembly further comprises a high pressure electric machine, wherein the control system is further in electric communication with the high pressure electric machine, the control system configured to receive data indicative of an electric power flow to or from the high pressure electric machine and determine health information of the gas turbine engine in response to the received data from the high pressure electric machine.

The propulsion system of any preceding clause, wherein the control system operates at a frequency of at least 250 hertz.

The propulsion system of any preceding clause, further comprising: an engine controller defining an operating frequency in communication with the control system, wherein the control system comprises a controller defining an operating frequency higher than the operating frequency of the engine controller.

A method for operating a propulsion system, the method comprising: receiving data from an electric machine indicative of an electric power flow to or from the electric machine, the electric machine rotatable with a shaft of a turbomachine of an aeronautical gas turbine engine; and determining health information of the gas turbine engine in response to the received data.

The method of any preceding clause, wherein receiving data from the electric machine comprises receiving data from the electric machine with a converter assembly operable with the electric machine, and wherein the method further comprises: providing a signal indicative of the electric power flow to or from the electric machine from the converter assembly to a controller.

The method of any preceding clause, wherein providing the signal indicative of the electric power flow to or from the electric machine from the converter assembly to the controller comprises: processing the data from the electric machine with the converter assembly; and providing the signal as a processed data signal.

The method of any preceding clause, wherein providing the signal indicative of the electric power flow to or from the electric machine from the converter assembly to the controller comprises providing a raw data signal from the converter assembly to the controller, and wherein the method further comprises: processing the raw data signal from the converter assembly with the controller to generate a processed data signal.

The method of any preceding clause, wherein determining the health information of the gas turbine engine in response to the received data comprises analyzing a processed data signal derived from the received data using a pattern recognition analysis.

The method of any preceding clause, wherein analyzing the processed data signal derived from the received data using the pattern recognition analysis comprises comparing the processed data signal to a library of signal patterns associated with processed data signals during various operations of the gas turbine engine.

A combustion engine assembly comprising: a combustion engine having a driven shaft; and an electric assembly comprising: an electric machine rotatable with the driven shaft; a control system in electric communication with the electric machine, the control system configured to receive data indicative of an electric power flow to or from the electric machine and determine health information of the combustion engine in response to the received data.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A propulsion system comprising:
a gas turbine engine having a turbomachine, the turbomachine comprising a compressor, a turbine, and a shaft rotatable with the turbine; and
an electric assembly comprising:
an electric machine rotatable with the shaft; and
a control system in electric communication with the electric machine, the control system configured to receive data from the electric machine indicative of an electric power flow to or from the electric machine and determine health information of the gas turbine engine in response to the received data, wherein the control system is configured to determine the health information of the gas turbine engine by comparing a processed data signal derived from the received data to a library of signal patterns associated with processed data signals during various operations of the gas turbine engine.

2. The propulsion system of claim 1, wherein the control system includes a converter assembly operable with the electric machine to condition the electric power flow to or from the electric machine.

3. The propulsion system of claim 2, wherein the control system is configured to receive the data with the converter assembly, wherein control system further comprises a controller configured to receive a signal indicative of the electric power flow to or from the electric machine from the converter assembly.

4. The propulsion system of claim 3, wherein the controller is further configured to process the signal indicative of the electric power flow to or from the electric machine.

5. The propulsion system of claim 3, wherein the converter assembly is further configured to process the data indicative of the electric power flow to or from the electric machine, and wherein the signal indicative of the electric power flow to or from the electric machine is a processed data signal.

6. The propulsion system of claim 1, wherein the control system is configured to determine the health information of the gas turbine engine using a pattern recognition analysis.

7. (canceled)

8. The propulsion system of claim 1, wherein the processed data signal is derived from the received data using a Fourier frequency transform.

9. The propulsion system of claim 1, wherein the control system comprises a controller having a detection module configured to determine the health information of the gas turbine engine using a machine learned model.

10. The propulsion system of claim 1, wherein the control system is further configured to instruct a responsive action to be taken in response to the determining the health information of the gas turbine engine is a failure event or failure condition.

11. The propulsion system of claim 1, wherein the compressor is a low pressure compressor, wherein the turbine is a low pressure turbine, wherein the shaft is a low pressure shaft, wherein the turbomachine further comprises a high pressure compressor, a high pressure turbine, and a high pressure shaft rotatable with high pressure turbine, wherein the electric machine is a low pressure electric machine, and wherein the electric assembly further comprises a high pressure electric machine, wherein the control system is further in electric communication with the high pressure electric machine, the control system configured to receive data indicative of an electric power flow to or from the high pressure electric machine and determine health information of the gas turbine engine in response to the received data from the high pressure electric machine.

12. The propulsion system of claim 1, wherein the control system operates at a frequency of at least 250 hertz.

13. The propulsion system of claim 1, further comprising:
an engine controller defining an operating frequency in communication with the control system, wherein the control system comprises a controller defining an operating frequency higher than the operating frequency of the engine controller.

14. A method for operating a propulsion system, the method comprising:
receiving data from an electric machine indicative of an electric power flow to or from the electric machine, the electric machine rotatable with a shaft of a turbomachine of a gas turbine engine; and
determining health information of the gas turbine engine in response to the received data by comparing a processed data signal derived from the received data to a library of signal patterns associated with processed data signals during various operations of the gas turbine engine.

15. The method of claim 14, wherein receiving data from the electric machine comprises receiving data from the electric machine with a converter assembly operable with the electric machine, and wherein the method further comprises:
providing a signal indicative of the electric power flow to or from the electric machine from the converter assembly to a controller.

16. The method of claim 15, wherein providing the signal indicative of the electric power flow to or from the electric machine from the converter assembly to the controller comprises:
processing the data from the electric machine with the converter assembly; and
providing the signal as a processed data signal.

17. The method of claim 15, wherein providing the signal indicative of the electric power flow to or from the electric machine from the converter assembly to the controller comprises providing a raw data signal from the converter assembly to the controller, and wherein the method further comprises:
processing the raw data signal from the converter assembly with the controller to generate a processed data signal.

18. The method of claim 14, wherein determining the health information of the gas turbine engine in response to the received data comprises analyzing a processed data signal derived from the received data using a pattern recognition analysis.

19. (canceled)

20. A combustion engine assembly comprising:
a combustion engine having a driven shaft; and
an electric assembly comprising:
an electric machine rotatable with the driven shaft; and
a control system in electric communication with the electric machine, the control system configured to receive data indicative of an electric power flow to or from the electric machine and determine health information of the combustion engine in response to the received data, wherein the control system is configured to determine the health information of the combustion engine by comparing a processed data signal derived from the received data to a library of signal patterns associated with processed data signals during various operations of the combustion engine.
